(19) United States
(12) Patent Application Publication
(10) Pub. No.: US 2016/0320922 A1
(43) Pub. Date: Nov. 3, 2016

(54) SERVICE METHOD AND SYSTEM FOR PROVIDING SERVICE BY ASSOCIATING APPSTORE WITH TIMELINE

(71) Applicant: NHN Entertainment Corporation, Seongnam-si (KR)

(72) Inventors: You Young KIM, Seongnam-si (KR); Hyojung LIM, Seongnam-si (KR); Jin Kyo CHUNG, Seongnam-si (KR)

(21) Appl. No.: 14/698,342

(22) Filed: Apr. 28, 2015

(51) Int. Cl. G06F 3/0482; H04L 29/08; G06F 3/0484

(52) U.S. Cl. CPC G06F 3/0482; G06F 3/0484; H04L 67/10

(57) ABSTRACT

Provided is a service method and system for providing a service by associating an application store (Appstore) with a timeline. A service method configured as a computer may include providing an Appstore service; providing a download page for an application provided by the Appstore; storing and maintaining information about a user registered to the Appstore service and friend information between the user and individuals having set a personal relationship with the user; enabling the user to select an application from among the applications provided by the Appstore and to upload a post through the Appstore service; and producing display content for a set of timelines, including a timeline of the user and timelines of the individuals having a set a personal relationship with the user, based on a user selection of the application and an uploading of a post relating to the selected application.

### BACKGROUND

1. Field

Exemplary embodiments relate to a service method and system for providing a service by associating an application store (Appstore) with a timeline.

2. Discussion

A smartphone may additionally install and use an application (hereinafter, referred to as “App”) corresponding to an application program. Apps may have different uses and purposes. In this regard, the smartphone may differ from a general mobile phone. In general, a user may download such an App by accessing, for example, an application store (Appstore) and install and use the downloaded App in the smartphone.

The term “Appstore” may refer to an online mobile contents market for selling a variety of Apps installable in a smartphone. Apps developed by developers such as individuals or companies may be uploaded to the Appstore and be sold or provided to users. In this case, the developers pay the Appstore a commission for selling or providing the Apps. That is, the developers may pay the existing Appstore a commission and distribute developed Apps through the existing Appstore, thereby allowing users to access the developed Apps.

Additionally or alternatively, developers may also provide Apps in an independent form through a separate uniform resource locator (URL). In this case, the developers may avoid the need to pay a commission on downloads using the separate URL, and thus, may have to pay a lower overall commission. However, user accessibility to, and awareness of, a storage location to download an App may be degraded.

The Appstore may also provide a download page with respect to an App. The download page may provide a link to download the App and may also include user-generated content, such as user comments on the corresponding App. However, the user-generated content sometimes reflects comments unrelated to the quality of the App, such as comments relating to an App download process or refund. Accordingly, it is difficult to obtain detailed and reliable information about the App itself, including tips on using the App, on the Appstore download page.

### SUMMARY

Exemplary embodiments provide a distributor management method and system that may manage distributors for distributing an application (App) provided in an independent form instead of using an existing application store (Appstore) and may induce the distributors to introduce and recommend the App to other users using a friend network or an existing business network. Exemplary embodiments also provide a service method and system that enables users considering downloading an App to obtain detailed and reliable information on the corresponding App.

Additional features will be set forth in the description which follows, and in part will be apparent from the description, or may be learned by practice.

Exemplary embodiments disclose a service method configured as a computer, the method including providing an application store (Appstore) service; providing a download page for an application provided by the Appstore; storing and maintaining information about a user registered to the Appstore service and friend information between the user and individuals having set a personal relationship with the user; enabling the user to select an application from among the applications provided by the Appstore and to upload a post through the Appstore service; and producing display content for a set of timelines, including a timeline of the user and timelines of the individuals having a set a personal relationship with the user, based on a user selection of the application and an uploading of a post relating to the selected application.

Exemplary embodiments disclose a service system including a storage unit; and a processing unit, wherein the processing unit is configured to: provide an application store (Appstore) service and a download page with respect to an application in the Appstore; store and maintain, in the storage unit, information about a user registered to the Appstore service and friend information between the user and individuals having a set personal relationship the user; enable the user to select an application from the Appstore and to upload a post through the Appstore service; and produce display content for a set of timelines, including a timeline of the user and timelines of the individuals having a set a personal relationship with the user, based on a user selection of the application and an uploading of a post relating to the selected application.

Exemplary embodiments also disclose a file distribution system for distributing a file for installing an application in a terminal of a user, the file distribution system including a file storage configured to store the file; and a file transmitter configured to transmit the file to the terminal in response to a request of the terminal, wherein the file comprises: a module configured to control the terminal to provide a user interface for creating a post to be displayed on a set of timelines, including a timeline of the user and a timeline of individuals having set a personal relationship with the user; a module configured to control the terminal to provide a user interface for selecting an application from an application store (Appstore) service and associating the selected application with the post; and a module configured to control the terminal to provide information about the post and information about the selected application to a service server providing the Appstore service.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating a distributor management environment according to one or more exemplary embodiments.

FIG. 2 is a diagram illustrating a distributor installing an application (App) on a user terminal and registering information about the distributor according to one or more exemplary embodiments.

FIG. 3 is a diagram illustrating registering a distributor through a recommender program according to one or more exemplary embodiments.

FIG. 4 is a diagram illustrating registering a distributor by participating in a member recruit event according to one or more exemplary embodiments.

FIG. 5 is a diagram illustrating registering a distributor by participating in a non-recruit event according to one or more exemplary embodiments.

FIG. 6 is a diagram illustrating a user directly registering a distributor according to one or more exemplary embodiments.

FIG. 7 is a flowchart illustrating a distributor management method according to one or more exemplary embodiments.

FIG. 8 is a flowchart illustrating a distributor management method according to one or more exemplary embodiments.

FIG. 9 illustrates a screen on which a timeline post is uploaded according to one or more exemplary embodiments.

FIG. 10 illustrates a timeline screen according to one or more exemplary embodiments.

FIG. 11 illustrates a service selection screen according to one or more exemplary embodiments.

FIG. 12 is a flowchart illustrating a service method according to one or more exemplary embodiments.

FIG. 13 is a flowchart illustrating a service method according to one or more exemplary embodiments.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of components, etc., may be exaggerated for clarity and descriptive purposes. Also, like reference numerals denote like elements.

When a component is referred to as being “on,” “connected to,” or “coupled to” another component, it may be directly on, connected to, or coupled to the other component or intervening components may be present. When, however, a component is referred to as being “directly on,” “directly connected to,” or “directly coupled to” another component, there are no intervening components present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various features, these features should not be limited by these terms. These terms are used to distinguish one feature from another. Thus, a first feature could be termed a second feature without departing from the teachings of the present disclosure.

Spatially relative terms, such as “beneath,” “below,” “lower,” “above,” “upper,” and the like, may be used herein for descriptive purposes, and, thereby, to describe one feature's relationship to another feature as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Various exemplary embodiments are described herein with reference to sectional illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not be construed as limited to the particular illustrations, but are to include deviations in shapes that result from, for instance, manufacturing. Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

Hereinafter, one or more exemplary embodiments are described in detail with reference to the accompanying drawings.

One or more exemplary embodiments can provide a function capable of selecting an App of an Appstore and uploading a timeline post associated with the selected App and a display of the uploaded timeline post based on timelines of corresponding users along with a download page of the corresponding App.

A distributor management method according to one or more exemplary embodiments may manage distributors and may induce the distributors to introduce and recommend an application to users using a friend network or an existing business network.

According to one or more exemplary embodiments, a distributor may introduce and recommend an App to users using a friend network of the distributor or an existing business network of the distributor. A distributor management system may manage information about such distributors and members recruited by the distributors, for example, users having downloaded Apps provided by the distributors. A distributor management system may determine rewards to be provided to the distributors based on sales made by the members. The determined rewards may be provided to the distributors, thereby inducing the distributors to introduce and recommend the Apps to many other users.

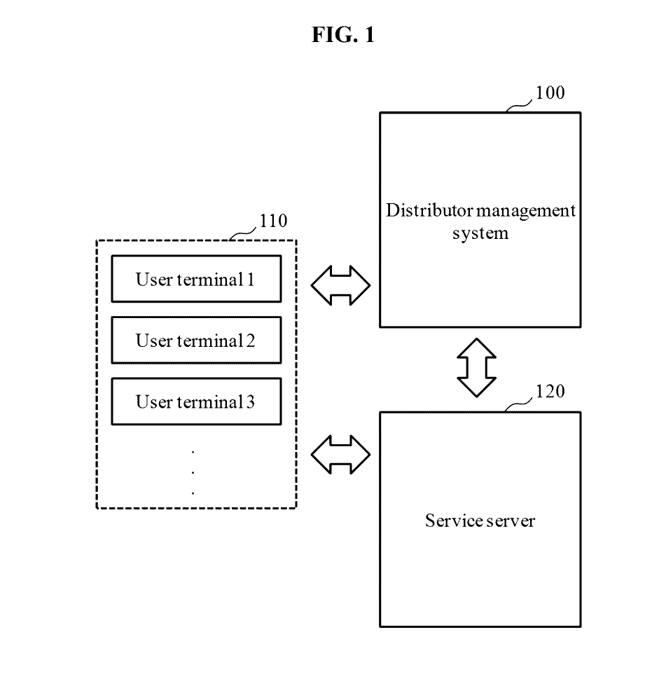

FIG. 1 is illustrates a distributor management environment according to one or more exemplary embodiments. As illustrated in FIG. 1, a distributor management environment may include distributor management system 100, plurality of user terminals 110, and service server 120.

As described above, distributor management system 100 may be a system to manage distributors and members, and to determine rewards to be provided to the distributors. Service server 120 may be a server to provide a service to a user terminal in response to a request of the user terminal in which an App is installed among plurality of user terminals 110. For example, distributor management system 100 may be a system included in service server 120 or a server separate from service server 120. When distributor management system 100 is configured separate from service server 120, distributor management system 100 and service server 120 may obtain required data through mutual communication therebetween. For example, information about sales generated by a member recruited by a distributor at service server 120 may be provided from service server 120 to distributor management system 100.

Plurality of user terminals 110 refer to terminals of users using or likely to use a service provided by service server 120, and may include a device capable of installing an App. Service may be provided to plurality of user terminals 110 through a connection to service server 120 over a network by the installed App.

Distributor management system 100 may verify whether to recruit a member based on whether information about a distributor is received. For example, when information about a distributor is received through a user terminal to install an App or when the user participates in a predetermined event, distributor management system 100 may verify that a specific distributor has recruited the user of the terminal as a member based on the information received about the distributor or information about the distributor preset with respect to the corresponding event.

Member recruitment may be performed in various manners as expressed by the following examples 1) through 5):
1) A distributor installs an App on a user terminal that registers information about the distributor;
2) A recommender recruits a member through a recommender program;
3) A distributor registers a member recruit event;
4) A distributor registers a non-recruiting specific event; and
5) A user directly registering a distributor.

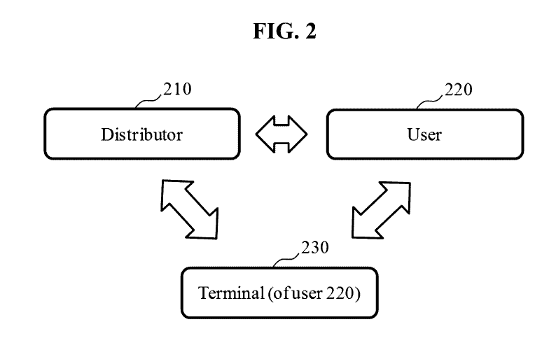

Examples 1) through 5) will be further described with reference to FIGS. 2 through 6.

FIG. 2 is a diagram illustrating a distributor installing an App in a terminal of a user and registering information about the distributor according to one or more exemplary embodiments.

Distributor 210 may directly install an App on user terminal 230 of user 220. The App that distributor 210 is to install on user terminal 230 may be installed by using a separate distributor package.

For example, the distributor package may be separately provided to distributor 210 and be stored in a terminal (not shown) of distributor 210, and may be transferred from the terminal of distributor 210 to user terminal 230 of user 220 over a network. Distributor 210 may install a required App using the distributor package transferred to user terminal 230.

In an exemplary embodiment, the distributor package may also be downloaded to user terminal 230 of user 220 through a separate uniform resource locator (URL). Information about the separate URL may be provided to distributor 210, and distributor 210 may download the distributor package through a connection to the URL using user terminal 230 of user 220.

An App installed through the distributor package may control user terminal 230 to provide a user interface for receiving an identifier (ID) of distributor 210 through terminal 230 in order to verify an initial execution of the App. For example, in response to an execution of the installed App after distributor 210 installs the App on user terminal 230, user terminal 230 may display the user interface on a screen by the installed App. In this example, the distributor 210 may input the ID of distributor 210 through the user interface.

The input ID of distributor 210 may be transferred directly from terminal 230 to distributor management system 100 of FIG. 1 by the App, or may be transferred to distributor management system 100 through service server 120. When distributor management system 100 is included in service server 120, transferring the ID of distributor 210 to service server 120 may correspond to transferring the ID of distributor 210 to distributor management system 100. When user 220 joins a service as a member through the App installed on user terminal 230 of user 220, the ID of distributor 210 may be transferred to distributor management system 100 or service server 120 to manage distributor 210 and user 220 through a mutual association therebetween. For example, when an ID of distributor 210 is input and user 220 completes joining the service, service server 120 may recognize user 220 or user terminal 230 of user 220. When the ID of distributor 210 is received, the ID of distributor 210 and the ID of user 220 may be transferred to distributor management system 100. In an exemplary embodiment, when user 220 completes joining the service, the ID of distributor 210 may be directly transferred to distributor management system 100 together with the ID of user 220.

Since distributor management system 100 stores the ID of distributor 210 and the ID of user 220 by associating the ID of distributor 210 and the ID of user 220, distributor management system 100 may set a member relationship between distributor 210 and user 220 by registering distributor 210 with respect to user 220. In this instance, user 220 may set a member relationship with a plurality of distributors and may also select a single distributor from among the plurality of distributors and may set a member relationship with the selected single distributor. User 220 may participate in member recruit events implemented by distributor A, distributor B, and distributor C, respectively, and may set a member relationship with all of the distributors A, B, and C. In this example, user 220 may also select at least one distributor as a primary distributor among the distributors A, B, and C. When user 220 selects the distributor A as a primary distributor, for example, distributor management system 100 may set a member relationship between user 220 and the distributor A as a primary member relationship.

Distributor management system 100 may determine rewards to be provided to distributor 210 based on sales associated with a service the user 220 joined.

When distributor 210 is registered with respect to user 220, distributor 210 may not be replaced although an App may be reinstalled on or deleted from user terminal 230 of user 220. Information about distributor 210 associated with user 220 may be stored and managed at distributor management system 100. Distributor 210 may be replaced with another distributor assigned to user 220 at predetermined periods or during a predetermined period.

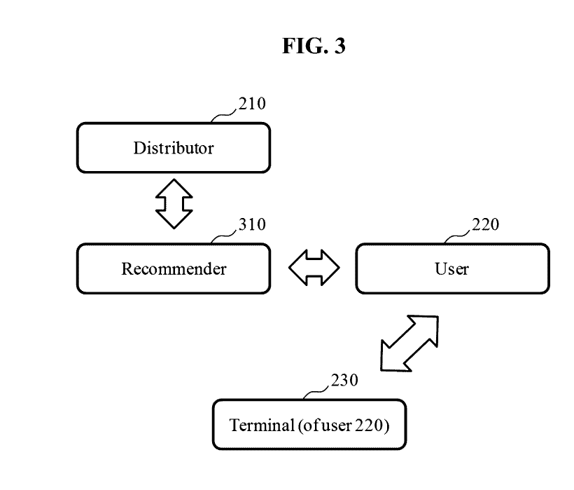

FIG. 3 is a diagram illustrating registering a distributor through a recommender program according to one or more exemplary embodiments. An App according to exemplary embodiments may control user terminal 230 of user 220 to provide a user interface for receiving a recommender through terminal 230 of user 220.

In an exemplary embodiment in which user 220 installs an App by downloading a file for installing the App through a predetermined path, for example, an installation guide message of recommender 310, a user interface for receiving an ID of recommender 310 may be provided through terminal 230 under control of recommender 310 at the time of joining a service. When user 220 inputs the ID of recommender 310 and completes joining the service, distributor 210 registered with respect to recommender 310 may also be registered with respect to user 220. The installation guide message of recommender 310 may be transferred to user 220 through, for example, a short message service (SMS), an email, and a social network service (SNS).

In an exemplary embodiment, a recommender registration confirmation message may be provided to recommender 310 and a new member registration confirmation message associated with recommender 310 may be provided to distributor 210. The recommender registration confirmation message and the new member registration confirmation message may be provided to recommender 310 and distributor 210, respectively, based on a timeline provided from service server 120. In an exemplary embodiment, the new member registration confirmation message may be provided to distributor 210 through a page or a service provided from distributor management system 100 to distributors. The timeline may be a service provided to users through an App, and may sort and display posts, for example, information such as texts, images, moving pictures, sounds, links, and events of users, for example, from friends having set a mutual personal relationship based on times at which the posts are uploaded. Such a timeline will be further described below.

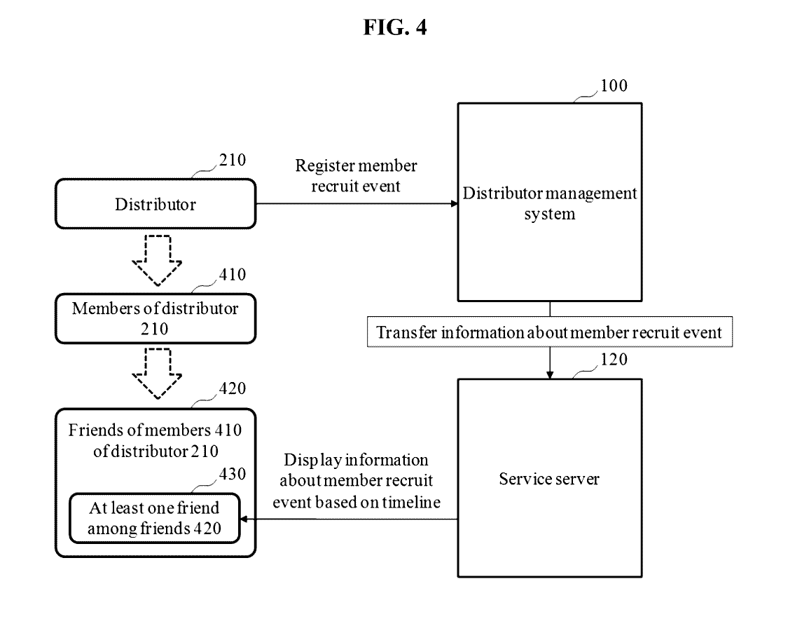

FIG. 4 is a diagram illustrating an example of registering a distributor by participating in a member recruit event according to one or more exemplary embodiments. A member recruit event may be executed by distributor 210. For example, distributor management system 100 may provide a user interface capable of executing a member recruit event through a distributor page provided to distributor 210. In this example, distributor 210 may register the member recruit event to distributor management system 100 using the user interface. In this instance, information about the registered member recruit event may be transferred from distributor management system 100 to service server 120. When distributor management system 100 is included in service server 120, a separate transfer process may not be required.

Service server 120 may display information about the member recruit event to a plurality of individuals based on a member's timeline. The plurality of users may include at least one user, for example, a friend 430 among users such as friends 420 having set a personal relationship with members 410 of distributor 210. For example, at least one friend 430 may include a friend not having set a member relationship with any distributor among the friends 420 of the members 410 of the distributor 210.

When information about the member recruit event is displayed to a specific user based on a timeline, the specific user may proceed to participate in an event based on the displayed information. For example, information about the member recruit event may include a link to a page to register distributor 210 to become a member of the distributor 210. In this example, the specific user may participate in an event using the link. In response to the participation in the member recruit event, distributor management system 100 may set a member relationship between distributor 210 and specific user.

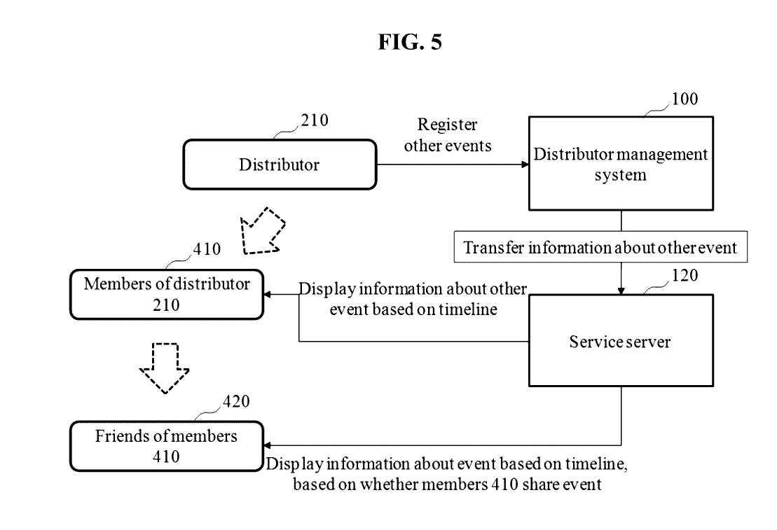

FIG. 5 is a diagram illustrating registering a distributor by participating in a non-recruit event according to one or more exemplary embodiments. The non-recruit event according to exemplary embodiments may be executed by distributor 210. Whether to execute the event may be set through a user interface of a distributor page provided from distributor management system 100.

When the non-recruit event is executed by distributor 210, distributor management system 100 may transfer information about the non-recruit event to service server 120. Service server 120 may display information about the non-recruit event to members 410 of distributor 210 based on a timeline. Members 410 of distributor 210 may share information about the non-recruit event with friends 420 of members 410. For example, service server 120 may enable users to share posts while providing a timeline service. Members 410 corresponding to a portion of users may share information about the non-recruit event with friends 420 of the members. In this case, service server 120 may display information about the non-recruit event to friends 420 of members 410 based on a timeline according to sharing of the event. For example, a member 1 having friends A, B, and C may share information about a non-recruit event with all of the friends A, B, and C, or may select friend(s), for examples, friends B and C from among the friends A, B, and C, and may share information about the non-recruit event with the selected friends B and C.

Each of friends 420 sharing information about the non-recruit event may determine whether to participate in the event. A friend having a different distributor with respect to the non-recruit event may not be allowed to participate in the non-recruit event. The friend with the different distributor may be allowed to replace the distributor within a predetermined distributor replacement period. In this case, the friend may be allowed to participate in the non-recruit event after replacing the distributor. A friend who does not have a different distributor and who desires to participate in the non-recruit event may be allowed to participate in the event at any time.

In response to the friend participating in the other event, distributor management system 100 may set a member relationship between distributor 210 and the friend participating in the other event and may transfer, to distributor 210, a message, for example, a new member registration confirmation message, to inform that a member is registered.

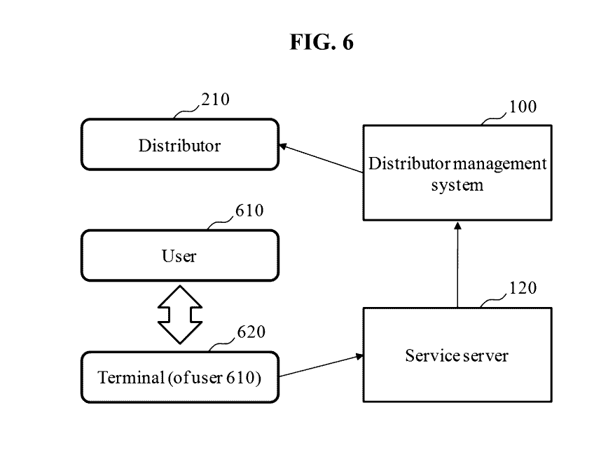

FIG. 6 is a diagram illustrating a user directly registering a distributor according to one or more exemplary embodiments. Referring to FIG. 6, user 610 may include a user that has not set a member relationship with any distributors. User 610 may verify that a distributor having set a member relationship is present through a user setting page provided through terminal 620 according to control of an App installed in terminal 620 of user 610. When a distributor having set a member relationship is absent, user 610 may input a specific distributor, for example, an ID of distributor 210 on the user setting page. In this case, terminal 620 may transfer the ID of distributor 210 to service server 120 according to control of the App.

Service server 120 may transfer the ID of distributor 210 to distributor management system 100, and distributor management system 100 may set a member relationship between distributor 210 and user 610.

The new member registration confirmation message may be transmitted to distributor 210. As described above, the new member registration confirmation message may be provided to distributor 210 through the distributor page provided from distributor management system 100, and may also be provided from service server 120 to distributor 210 based on a timeline provided through the App.

An App according to one or more exemplary embodiments may be, for example, an App for providing an application store (Appstore) to users. In this case, the users may download and utilize various Apps provided through the Appstore. Distributors according to one or more exemplary embodiments may explain to or induce users to install the App for providing the Appstore. For example, a distributor may be an entity that sells smartphones to businesses. A smartphone seller may install the App for providing an Appstore prior to or in association with selling a smartphone to a smartphone purchaser and may register the smartphone seller as a distributor. When the smartphone purchaser performs a predetermined act, for example, purchasing Apps within the Appstore and purchasing a service or a digital item within the purchased Apps, through the Appstore providing App, rewards based on the predetermined act, for example, rewards based on sales made by the smartphone purchaser in association with the Appstore providing App may be awarded to the smartphone seller.

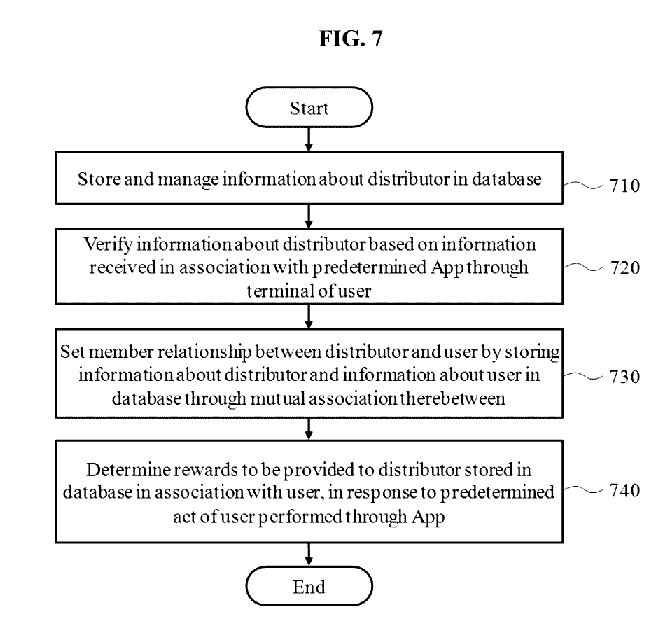

FIG. 7 is a flowchart illustrating a distributor management method according to one or more exemplary embodiments. The distributor management method may be performed by distributor management system 100. Distributor management system 100 may be configured as a computer including at least one storage unit and at least one processor, and operations included in the distributor management method may be processed by the at least one processor.

In operation 710, distributor management system 100 may store and manage information about a distributor in a database. The distributor may promote an App to users, including preselected users, and request that they install the App. Information about the distributor may be input to distributor management system 100 and may be stored and managed in the database at the time of registering the distributor or as an updating process. The database may be stored and managed in at least one storage unit according to processing of at least one processor included in distributor management system 100.

In operation 720, distributor management system 100 may verify information about the distributor based on information received in association with the predetermined App through a user terminal.

According to one or more exemplary embodiments, distributor management system 100 may further receive an ID of the distributor input during installing the App in the user terminal and may verify the received ID of the distributor as information about the distributor in operation 720. An exemplary embodiment in which the distributor directly inputs the ID of the distributor when the distributor directly installs the App in the user terminal is described above with reference to FIG. 2. In this case, the distributor management system 100 may verify the ID of the distributor received through the terminal, as information about the distributor. As described above, when distributor management system 100 is a system separate from service server 120 of FIG. 1, data may be transmitted and received through network communication with service server 120.

According to one or more exemplary embodiments, distributor management system 100 may receive an ID input by another user through a user interface provided from the user terminal according to control of the App when the App is installed in the terminal in response to a message transferred to the user from the other user having set a member relationship with the distributor, and may verify information about the distributor from the database based on the ID of the other user in operation 720. An exemplary embodiment of registering a distributor through a recommender program is described above with reference to FIG. 3, and thus, a repeated description is omitted.

According to one or more exemplary embodiments, distributor management system 100 may receive registration of information about a member recruit event from the distributor, receive, by a terminal in which an App is installed, information associated with the member recruit event when a user participates in the member recruit event provided to the user through the terminal according to control of the App, and verify information about the distributor based on the registered information about the member recruit event in operation 720. An exemplary embodiment of the member recruit event is described above with reference to FIG. 4. Distributor management system 100 may identify the distributor based on information about the member recruit event in which the user participates.

According to one or more exemplary embodiments, although not illustrated, distributor management system 100 may receive registration of information about another event from the distributor, receive, by a terminal in which an App is installed, information associated with the other event when a user participates in the other event provided to the user being shared by another user having set a member relationship with the distributor, and verify information about the distributor based on information associated with the other event and the registered information about the other event in operation 720. As described above with reference to FIG. 5, the other event may be provided to the user by sharing the other event between a member of the distributor and a friend of the member. The distributor may be matched in association with the user through participation in the other event. Distributor management system 100 may identify the distributor based on information about the other event in which the user participates.

According to one or more exemplary embodiments, although not illustrated, distributor management system 100 may receive, by a terminal in which an App is installed, an ID of the distributor input through a user page when the user page is provided to the user through the terminal according to control of the App and verify the ID of the distributor as information about the distributor in operation 720. As described above with reference to FIG. 6, a user may input the ID of the distributor using the user interface provided from the App, for example, a user information setting interface on the user page, and distributor management system 100 may identify the distributor based on the input ID of the distributor.

In operation 730, the distributor management system 100 may set a member relationship between the distributor and the user by storing information about the distributor and the user in the database based on a mutual association therebetween. The settings may be set such that a single distributor is capable of making member relationships with one or more of user(s) while a single user is allowed to make a member relationship with only a single distributor. In this example, the distributor set with respect to a user may be replaced at predetermined periods or after a predetermined period. Aspects of the invention are not limited thereto, and a user may make member relationships with one or more distributors.

In operation 740, distributor management system 100 may determine rewards to be provided to the distributor stored in the database in association with the user, in response to a predetermined act performed by the user through the App. For example, the predetermined act may include at least one of an act of purchasing another App, a product, a service, or digital content being sold at the App, and an act of installing the other App in the terminal. The App may provide an Appstore service providing a plurality of other Apps. In this case, the predetermined act may include at least one of an act of installing at least one App among the plurality of other Apps provided by the Appstore on the terminal and an act of purchasing a product, a service, or digital content of one or more such App.

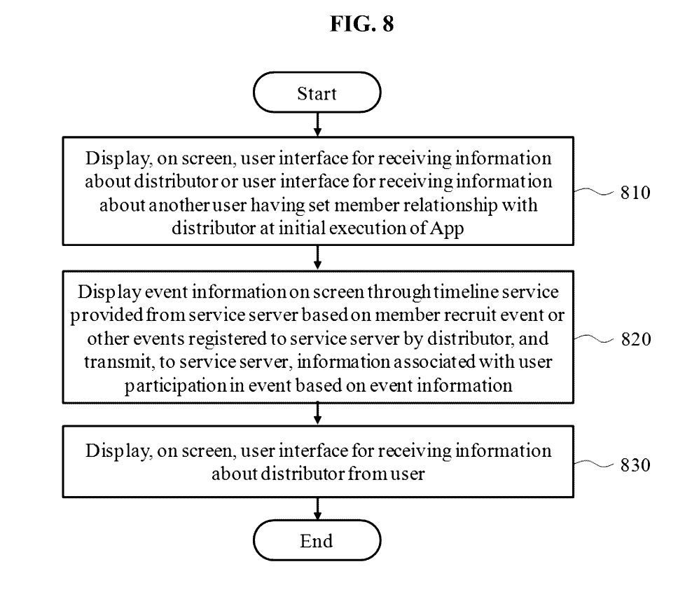

FIG. 8 is a flowchart illustrating a distributor management method according to one or more exemplary embodiments. The distributor management method may be performed by a user terminal. An App may be installed on the user terminal and may include modules configured to control the terminal to perform operations included in the distributor management method.

In operation 810, the terminal may display, on a screen, a user interface for receiving information about a distributor or a user interface for receiving information about another user having set a member relationship with the distributor during initial execution of the App. Receiving information about the distributor may correspond to the example referred to in FIG. 2 in which the distributor inputs an ID of the distributor while directly installing the App on the user terminal. Receiving information about the other user may correspond to the example referred to in FIG. 3 in which the user inputs an ID of a recommender.

In operation 820, the terminal may display event information on the screen through a timeline service provided from a service server based on a member recruit event or other events registered to the service server by the distributor. The terminal may transmit, to the service server, information associated with a user participation in an event based on event information. Exemplary embodiments of the member recruit event and the other event are described above with reference to FIGS. 4 and 5.

In operation 830, the terminal may display, on the screen, a user interface for receiving information about the distributor from the user.

Operation 820 may be performed when information about the distributor or the other user is not input in operation 810, and operation 830 may be performed when a member relationship between the user and the distributor is not set based on whether the user participates in the event in operation 820.

Information about the distributor and information about the other user may be included in the service server based on whether the user participates in the event. Alternatively, a member relationship between the distributor and the user may be set by storing the distributor and the user in a distributor management system associated with the service server through a mutual association between the distributor and the user.

An App to be installed in the terminal may be installed on the terminal by a file transmitted from a file distribution system. The file distribution system may include a file storage (not shown) configured to store and maintain the file and a file transmitter (not shown) configured to transmit the file to the terminal in response to a request of the terminal.

Any reference made above regarding FIGS. 7 and 8 not shown may refer to the description made with reference to FIGS. 1 through 6.

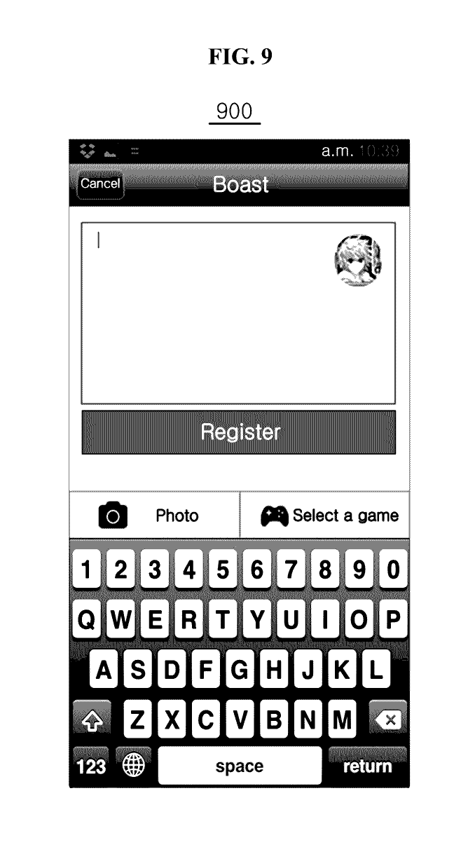

FIG. 9 illustrates a screen on which a timeline post is uploaded according to one or more exemplary embodiments. Screen 900 is an exemplary mobile terminal screen of a user. The user may upload, to service server 120, posts including a variety of data such as a text, an image, a moving picture, and a link, using a user interface displayed on screen 900 of a mobile terminal according to a control of an App.

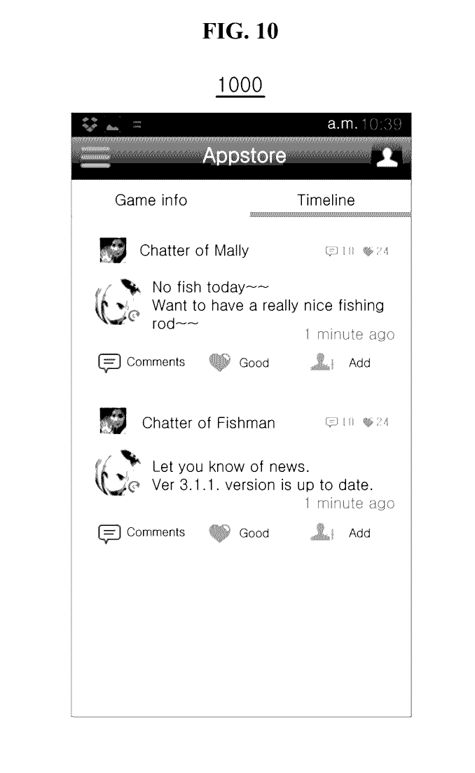

FIG. 10 illustrates a timeline screen according to one or more exemplary embodiments. Screen 1000 shows an exemplary embodiment of a screen on which posts uploaded by users are sorted in order of times at which the posts are uploaded and are displayed on a mobile terminal of a user. Instead of displaying all the posts to a single user, posts, for example, of friends having set a personal relationship with the corresponding user may be displayed on a timeline of the user. Additionally, notices or event news provided from the service server 120 or event information of the distributor may be displayed as posts on the timeline of the user.

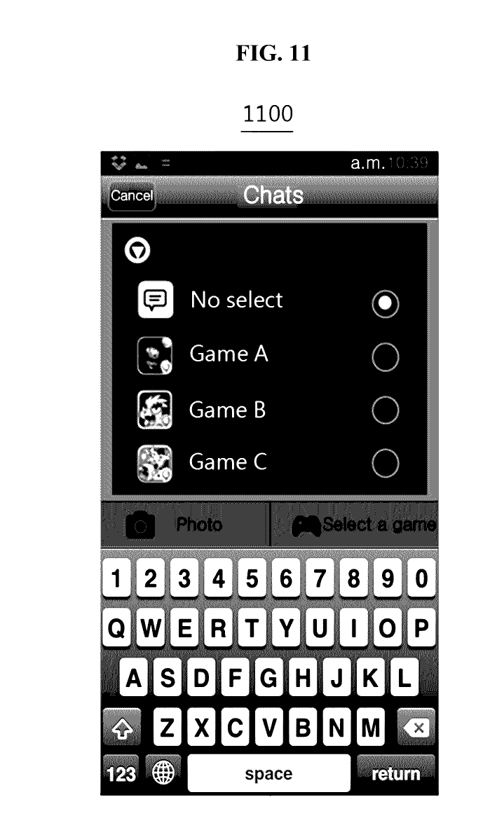

FIG. 11 illustrates a service selection screen according to one or more exemplary embodiments. Screen 1100 shows an example capable of selectively uploading a post for a timeline with respect to each game, the game being associated with or downloaded from an App for an Appstore that provides a plurality of game Apps included as a portion of its services. For example, when the user touches a “select a game” interface in FIG. 9, screen 1100 may be displayed to the user. For example, when the user is to upload a post for informing an achievement level of the user with respect to a specific game or to upload a post for providing a game tip with respect to the game, the user may select a desired game using a user interface displayed on screen 1100. A text, an image, a moving picture, or a link associated with the specific game may be automatically added to the post with respect to the specific game.

The Appstore may provide a game download page for each game included in the Appstore. A post uploaded by the user by selecting the specific game may be displayed on a timeline of the user and timelines of other users, for example, friends having set a personal relationship with the user, and may also be displayed through a game download page of the game. Users who download the game may obtain a large amount of information or tips about the game.

A timeline service according to exemplary embodiments may be serviced through the Appstore that is provided to users using an application installed by a distributor. However, the timeline service may be applied to an existing Appstore, for example, Appstore in operation by an existing platform provider such as Google and Apple, whereby a service may be provided so that posts uploaded by users by selecting a specific game may be shared between users having set a personal relationship therebetween. For example, a function of selecting a single application and uploading a post using an Appstore of an existing platform provider and displaying an uploaded post on a timeline of a corresponding user and timelines of other users having set a personal relationship with the corresponding user may be provided. That is, in exemplary embodiments, “Appstore” to which the timeline service is applied may indicate a platform that includes a plurality of applications and enables users to download the plurality of applications, such as provided by Facebook.

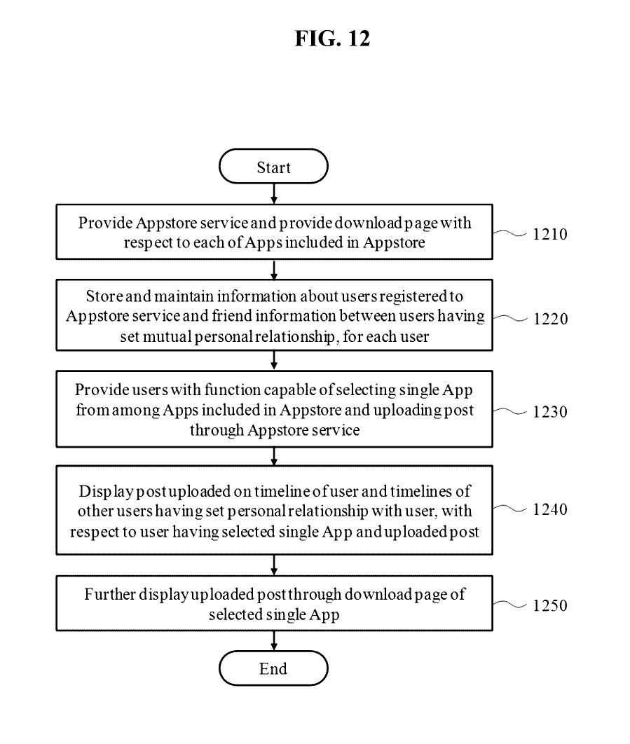

FIG. 12 is a flowchart illustrating a service method according to one or more exemplary embodiments. The service method may be performed by a service system. Here, the service system may correspond to the aforementioned service system 120. The service system may include at least one storage unit and at least one processor, and operations included in the service method may be processed by the at least one processor.

In operation 1210, the service system may provide an Appstore service and may provide a download page with respect to each of Apps included in the Appstore. For example, the Appstore service may be provided to users through an App, for example, an Appstore application installed on user terminals.

In operation 1220, the service system may store and maintain information about users registered to the Appstore service and friend information between users having set a mutual personal relationship, for each user. Here, the friend information may be stored and maintained in at least one storage unit according to processing of the at least one processor included in the service system.

In operation 1230, the service system may select a single App from among the Apps included in the Appstore and may upload a post through the Appstore service. The users may receive a user interface for selecting a single App from among the Apps included in the Appstore through the App, for example, the Appstore application installed in the terminals of the users, and may receive a user interface capable of uploading a post. In response to a selection of the user on the single App, the service system may verify information about the selected App and information about the post that are received from the user terminal.

In operation 1240, the service system may display the uploaded post on a timeline of the user and timelines of other users having set a personal relationship with the user, with respect to the user having selected the single App and uploaded the post. The other users having set the personal relationship with the user may be identified based on the aforementioned friend information.

In operation 1250, the service system may further display the uploaded post through a download page of the selected single App. A user uploading a post with respect to a predetermined App may have detailed information about the App. Accordingly, further detailed information may be added to the download page.

According to one or more exemplary embodiments, Apps included in the Appstore may be Apps required to execute different games. In this case, the Appstore may act as a mobile game portal to provide a plurality of games.

According to one or more exemplary embodiments, the service system may add, to a post uploaded by selecting a single App, at least one of a text, an image, a moving picture, and a link associated with the single App and may display the uploaded post in operations 1240 and 1250.

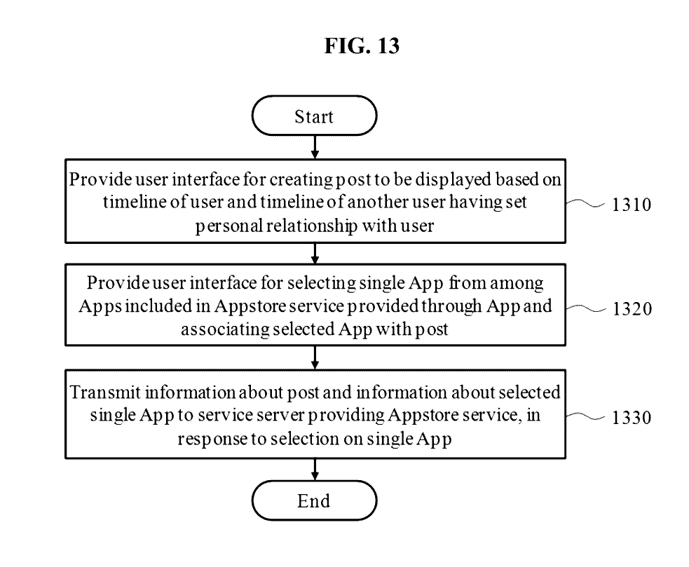

FIG. 13 is a flowchart illustrating a service method according to one or more exemplary embodiments. The service method may be performed by a terminal of a user. An App for providing an Appstore service may be installed on the terminal. The App may include modules configured to control the terminal to perform operations included in the service method.

In operation 1310, the terminal may provide a user interface for creating a post to be displayed on a timeline of user A and a timeline of user B having set a personal relationship with user A. User B having set the personal relationship with user A may be identified based on friend information maintained in a service server providing an Appstore service. The friend information may include information about the users between whom the mutual personal relationship is set.

In operation 1320, the terminal may provide a user interface for selecting a single App from among Apps included in an Appstore service provided through the App and associating the selected App with the post. The user interface for associating a post and an App has been described with reference to FIG. 11, and thus, a further description related thereto is omitted here.

In operation 1330, the terminal may transmit information about the post and information about the selected single App to the service server providing the Appstore service, in response to a selection on the single App.

Here, at the service server, the post associated with the single App may be added to a download page provided with respect to the single App. As described above, irrespective of download of an App, a user that is to upload a post with respect to a specific App may have detailed information about the App, and may add such information to the download page.

Apps included in the Appstore may be Apps required to execute different games.

In addition, at the service server, information about at least one of a text, an image, a moving picture, and a link associated with the single App may be added to the post associated with the single App. In this case, the post to which at least one item of information is added may be displayed on a timeline of the user and timelines of other users having set a personal relationship with the user.

Any reference made above regarding FIGS. 12 and 13 not shown in FIGS. 12 and 13 may refer to the description made above with reference to FIGS. 1 through 11.

According to one or more exemplary embodiments, it is possible to manage distributors for distributing an App provided in an independent form instead of using an existing Appstore and to induce the distributors to introduce and recommend the App to other users using a friend network or an existing business network. Also, according to exemplary embodiments, users that are to download an App may obtain a large amount of detailed information or tips on the corresponding App by being able to select an App of an Appstore and uploading a timeline post associated with the selected App, and by displaying the uploaded timeline post based on timelines of corresponding users and a download page of the corresponding App.

The units described herein may be implemented using hardware components, software components, or a combination thereof. For example, a processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums.

The above-described example embodiments may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described example embodiments, or vice versa.

Although a few example embodiments have been shown and described, the present invention is not limited to the described example embodiments. Instead, it would be appreciated by those skilled in the art that changes may be made to these example embodiments without departing from the principles and spirit of the invention, the scope of which is defined by the claims and their equivalents.

What is claimed is:

1. A service method, the method comprising:
providing an application store (Appstore) service;
providing a download page for an application provided by the Appstore;
storing and maintaining information about a user registered to the Appstore service and friend information between the user and individuals having set a personal relationship with the user;
enabling the user to select an application from among the applications provided by the Appstore and to upload a post through the Appstore service; and
producing display content for a set of timelines, including a timeline of the user and timelines of the individuals having a set a personal relationship with the user, based on a user selection of the application and an uploading of a post relating to the selected application.

2. The method of claim 1, wherein the Appstore provides a plurality of applications to execute different games.

3. The method of claim 1, wherein the producing display content comprises adding, in addition to content of the uploaded post, at least one of:
text associated with the application,
an image associated with the application,
a moving picture associated with the application, and
a link associated with the application.

4. The method of claim 1, further comprising providing the display content through the download page.

5. Non-transitory computer-readable storage media storing a program causing a processing unit to execute a method, the method comprising:
providing an application store (Appstore) service;
providing a download page for an application provided by the Appstore;
storing and maintaining information about a user registered to the Appstore service and friend information between the user and individuals having set a personal relationship with the user;
enabling the user to select an application from among the applications provided by the Appstore and to upload a post through the Appstore service; and
producing display content for a set of timelines, including a timeline of the user and timelines of the individuals having a set a personal relationship with the user, based on a user selection of the application and an uploading of a post relating to the selected application.

6. A service system comprising:
a storage unit; and
a processing unit,
wherein the processing unit is configured to:
provide an application store (Appstore) service and a download page with respect to an application in the Appstore;
store and maintain, in the storage unit, information about a user registered to the Appstore service and friend information between the user and individuals having a set personal relationship the user;
enable the user to select an application from the Appstore and to upload a post through the Appstore service; and
produce display content for a set of timelines, including a timeline of the user and timelines of the individuals having a set a personal relationship with the user, based on a user selection of the application and an uploading of a post relating to the selected application.

7. The service system of claim 6, wherein the Appstore provides a plurality of applications to execute different games.

8. The service system of claim 6, wherein the processing unit is further configured to produce display content comprising adding, in addition to content of the uploaded post, at least one of:
text associated with the application,
an image associated with the application,
a moving picture associated with the application, and
a link associated with the application.

9. The service system of claim 6, wherein the processing unit is configured to provide the display content through the download page.

10. A file distribution system for distributing a file for installing an application in a terminal of a user, the file distribution system comprising:
a file storage configured to store the file; and
a file transmitter configured to transmit the file to the terminal in response to a request of the terminal,
wherein the file comprises:
a module configured to control the terminal to provide a user interface for creating a post to be displayed on a set of timelines, including a timeline of the user and a timeline of individuals having set a personal relationship with the user;
a module configured to control the terminal to provide a user interface for selecting an application from an application store (Appstore) service and associating the selected application with the post; and
a module configured to control the terminal to provide information about the post and information about the selected application to a service server providing the Appstore service.

11. The file distribution system of claim 10, wherein the Appstore provides a plurality of applications to execute different games.

12. The file distribution system of claim 10, wherein the service server produces display content comprising, in addition to content of the post, at least one of:
text associated with the application,
an image associated with the application,
a moving picture associated with the application, and
a link associated with the application, and
wherein the display content is for display on the set of timelines.

13. The file distribution system of claim 10, wherein, at the service server, display content is produced to display the post through a download page for the selected application.
